(19) United States
(12) Patent Application Publication
(10) Pub. No.: US 2011/0232597 A1
(43) Pub. Date: Sep. 29, 2011

(54) METHOD AND DEVICE FOR CONTROLLING AN ENGINE STOP/RESTART SYSTEM TO BE MOUNTED ON AN AUTOMOBILE

(75) Inventors: Daniel Benchetrite, Creteil (FR); Benoit Soucaze-Guillous, Saint Maur Des Fosses (FR); Ertugrul Taspinar, Sucy-En-Brie (FR); Magali Laurence, Paris (FR); Paul Eric Chupin, Rueil-Malmaison (FR); Frédéric Devanne, Vincennes (FR); Brice Lecole, Paris (FR); Benoit Gareil, Saint Leonard (FR)

(73) Assignee: VALEO EQUIPEMENTS ELECTRIQUES MOTEUR, Creteil Cedex (FR)

(21) Appl. No.: 12/674,378

(22) PCT Filed: Jul. 28, 2008
(86) PCT No.: PCT/FR2008/051416

§ 371 Date: Jun. 13, 2011

(30) Foreign Application Priority Data
Aug. 23, 2007 (FR) 0757149

(51) Int. Cl. F02N 11/08

(52) U.S. Cl. 123/179.4

(57) ABSTRACT

A method and a device (5) for controlling an engine stop/restart system (1) to be mounted on an automobile. The device (5) includes a control module (6) that obtains at least one parameter (Tbat, Ubat, Ibat) representative of the state of an energy storage unit (8), determines information on the energetic state of the energy storage unit (8) from said at least one obtained parameter (Tbat, Ubat, Ibat), and controls the engine stop/restart system (1) based on the determined energetic state information. The energetic state information is set at a predetermined value when the method controls a stop authorization of the engine stop/restart system (1).

The present invention concerns a method and a device for controlling an engine stop/restart system fitted to a motor vehicle.

In engine stop/restart systems, there can be problems of availability of the stop and restart functions of the heat engine, as these functions are affected by the status of the battery.

In a vehicle containing an engine stop/restart system, it would be desirable to be able to use a system for managing the electrical power in the vehicle.

In a conventional electrical power management system in a vehicle, a battery and a rotary electrical machine supply power to the electrical consumers.

The rotary electrical machine, which may function as an alternator, is also intended to recharge the battery via a regulating device.

Typically, when the heat engine of the vehicle is functioning, the alternator supplies the electric consumers and charges the battery. When the alternator does not deliver any current, the battery supplies all of the electrical energy required by the vehicle.

As the number of electrical consumers fitted to the vehicle increases, it is necessary to practise intelligent management of the state of the battery, in particular so that it is always possible to start the heat engine.

Arranging this management in a vehicle requires knowledge of the energetic state of the battery.

It is not easy to know precisely the energetic state of the battery. The factors affecting the performance of the battery are, for example, the state of charge (“SOC”), the capacity, the level of concentration of electrolyte, the charge conditions, the temperature, and internal resistance. Certain parameters also depend on the conditions of use.

The patent FR 2853081 discloses a device for determining the instantaneous state of charge (SOC) of an energy storage battery for a motor vehicle, applied in a battery management system and capable of ordering corrective actions. The device is provided to order the disconnection of electrical functions such as a car radio, an air conditioning device or a parking assistance device. The device comprises an extended Kalman filter circuit which receives, as input, information concerning an initial state of charge of the battery, a voltage measured at the terminals of the battery and a temperature thereof. This information, with the aid of the extended Kalman filter, allows the instantaneous state of charge of the battery to be determined, while the vehicle is in use.

The determination device described in the patent FR 2853081 is not suited to an engine stop/restart system. Moreover, this device results in a complex implementation of an extended Kalman filter.

Furthermore, the type of device according to the patent FR 2853081 can only be used for a given battery, hence the need to modify the determination device, and more particularly the Kalman filter, for each model of battery.

So there is a need to know the energetic state of the battery in a way which is reliable, simple, and standard, at least for batteries of one technology, in order to enable the utilisation of the battery to be managed in intelligent and optimal conditions, and also to improve the performances of engine stop/restart systems, especially in terms of respect for the environment.

The object of the invention is to respond to the aforementioned needs.

According to a first aspect, the invention concerns a method for controlling an engine stop/restart system fitted to a motor vehicle. The control method comprises the steps of:
obtaining at least one parameter representing a state of an energy storage unit,
determining energetic state information of the energy storage unit on the basis of said at least one obtained parameter, and
controlling the engine stop/restart system depending on the determined energetic state information.

According to the invention, the energetic state information is initialised at a predetermined value when the method controls a stop authorisation of the engine stop/restart system.

The order to authorise the stop by the engine stop/restart system is characteristic of a sufficient energetic state of the energy storage unit.

The initialisation of said energetic state at this instant allows a reference energetic state to be defined, on the basis of which the management of the battery is effected.

On the basis of this reference energetic state, it is thus possible to manage the battery simply and reliably, in particular by defining fixed thresholds for energetic states, these thresholds being associated in particular with the commands of the engine stop/restart system.

With the aid of the invention, the engine stop/restart system is utilised optimally depending on the energetic state of the energy storage unit. So the risks, for example of the heat engine failing to restart following a stop, are eliminated. The operating safety of the vehicle is thus improved.

Moreover, the method is simple and standard to implement for a range of different energy storage units.

According to different embodiments of the method, the parameter comprises at least one of the following parameters:
a temperature representing a heat state of the energy storage unit,
a voltage representing an electrical state of the energy storage unit,
a current representing an electrical state of the energy storage unit.

According to one particular embodiment of the method, the step of determining the energetic state information comprises the sub-steps of:
determining a state of charge depending on the voltage and the temperature of the energy storage unit, and
comparing the determined state of charge to a threshold value of a predetermined state of charge.
   The state of charge may be determined depending on a type of energy storage unit. By type, one means a set of energy storage units having similar technologies, for example lead battery, and different characteristics. These characteristics can, for example, be the voltage, the current, and the capacity of the energy storage unit.

According to another particular embodiment of the method, the step of determining the energetic state information comprises the sub-steps of:
determining a threshold value of the current depending on the temperature of the energy storage unit, and
comparing the current of the energy storage unit to the determined threshold value of current.

According to one particular embodiment of the method, the step of determining the energetic state information comprises the sub-steps of:
determining an energy balance depending on the current of the energy storage unit, and
comparing the determined energy balance to a predetermined threshold value of energy balance.

According to yet another particular embodiment of the method, the step of determining the energetic state information comprises a sub-step of comparing the voltage of the energy storage unit to a predetermined threshold voltage value.

According to a first embodiment of the invention, the step of controlling the engine stop/restart system comprises a sub-step of authorising an engine stop.

According to one characteristic of this first embodiment of the invention, the sub-step of authorising an engine stop is carried out when the state of charge of the energy storage unit is greater than or equal to the predetermined threshold state of charge value.

According to another characteristic of this first embodiment of the invention, the sub-step of authorising an engine stop is carried out when the current of the energy storage unit is less than or equal to the determined threshold value of current. This characteristic is advantageous when the energy storage unit is in what is known as a state of charge.

According to one particular characteristic of this first embodiment of the invention, the sub-step of authorising an engine stop is carried out when the energy balance of the energy storage unit is greater than or equal to the predetermined threshold value of energy balance.

In this case, the energy balance is initialised at a predetermined value, for example zero.

According to yet another characteristic of this first embodiment of the invention, the sub-step of authorising an engine stop is carried out when:
the energy balance of the energy storage unit is greater than or equal to the predetermined threshold value of energy balance, and
the current of the energy storage unit is less than or equal to the determined threshold value of current.

If necessary, the energy balance is initialised at a predetermined value, for example zero.

This characteristic is interesting when the energy storage unit is in what is known as a state of charge.

According to a second embodiment of the invention, the step of controlling the engine stop/restart system comprises a sub-step of prohibiting an engine stop.

According to one characteristic of this second embodiment of the invention, the sub-step of prohibiting an engine stop is carried out when the energy balance of the energy storage unit is less than or equal to the predetermined threshold value of energy balance.

According to one particular characteristic of this second embodiment of the invention, the sub-step of prohibiting the engine stop may be carried out when the voltage of the energy storage unit is less than or equal to a predetermined threshold value of voltage. This characteristic is interesting when the energy storage unit is in what is known as a state of no charge.

According to a third embodiment of the invention, the step of controlling the engine stop/restart system comprises a sub-step of requesting an engine restart. When the energy storage unit is not charging, this third embodiment enables the restart of the vehicle following a stop which has led to a degradation of the energetic state of the energy storage unit.

According to one characteristic of this third embodiment of the invention, the sub-step of requesting an engine restart is carried out when the voltage of the energy storage unit is less than or equal to a predetermined threshold value of voltage.

According to another characteristic of this third embodiment of the invention, the sub-step of requesting an engine restart is carried out when the energy balance of the energy storage unit is less than or equal to the predetermined threshold value of energy balance.

According to a fourth embodiment of the invention, the step of controlling the engine stop/restart system comprises a sub-step of cancelling an engine restart request.

According to one characteristic of this fourth embodiment of the invention, the sub-step of cancelling an engine restart request is carried out when the energy balance of the energy storage unit is greater than or equal to the predetermined threshold value of energy balance.

According to another characteristic of this fourth embodiment of the invention, the sub-step of cancelling an engine restart request is carried out when the current of the energy storage unit is less than or equal to the determined threshold value of current.

According to one particular characteristic of the invention, the step of determining the energetic state information of the energy storage unit is preceded by a step of comparing the temperature of the energy storage unit to a predetermined threshold value of temperature.

The step of determining the energetic state information of the energy storage unit may be carried out when the temperature of the energy storage unit is greater than or equal to the predetermined threshold value of temperature.

Furthermore, when the temperature of the energy storage unit is less than the predetermined threshold value of temperature, the control module may control the engine stop/restart system so as to prohibit an engine stop.

According to one particular characteristic of the invention, the step of determining the energetic state information of the energy storage unit is preceded by the steps of:
determining a reference voltage depending on the temperature of the energy storage unit, and
comparing the voltage of the energy storage unit to the determined reference voltage.

The step of determining the energetic state information of the energy storage unit may be carried out when the voltage of the energy storage unit is essentially equal to the determined reference voltage.

Furthermore, when the voltage of the energy storage unit is not essentially equal to the determined reference voltage, the control module may control the engine stop/restart system so as to prohibit an engine stop.

According to a second aspect, the invention concerns a device for controlling an engine stop/restart system suitable for fitting to a motor vehicle, comprising a control module, said control module comprising:
means of obtaining at least one parameter representing the state of an energy storage unit,
means of determining energetic state information of the energy storage unit from said at least one obtained parameter, and
means of controlling the engine stop/restart system depending on the determined energetic state information.

According to one characteristic of the invention, the control module is at least partially integrated into a control unit and intended to control the engine stop/restart system.

According to another characteristic of the invention, the means of obtaining at least one parameter representing the state of an energy storage unit comprises sensors provided to obtain at least one of the following parameters:
a temperature of the energy storage unit,
a voltage of the energy storage unit,
a current of the energy storage unit.

The sensors may be placed on the energy storage unit.

If desired, the control module may be placed in the sensors.

According to a third aspect, the invention concerns an engine stop/restart system comprising a rotary electrical machine, a reversible analogue-digital converter and means of controlling the control device.

The rotary electrical machine may be an alternator-starter.

According to one final aspect, the invention concerns a motor vehicle comprising an engine stop/restart system.

Other characteristics and advantages of the invention will become apparent on reading the detailed description which follows, which will be better understood by making reference to the figures it contains, among which:

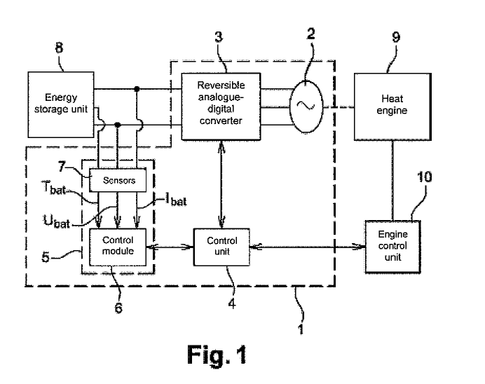

FIG. 1 shows a global view of an engine stop/restart system 1 containing a control module 6 for a control device 5 according to the invention,

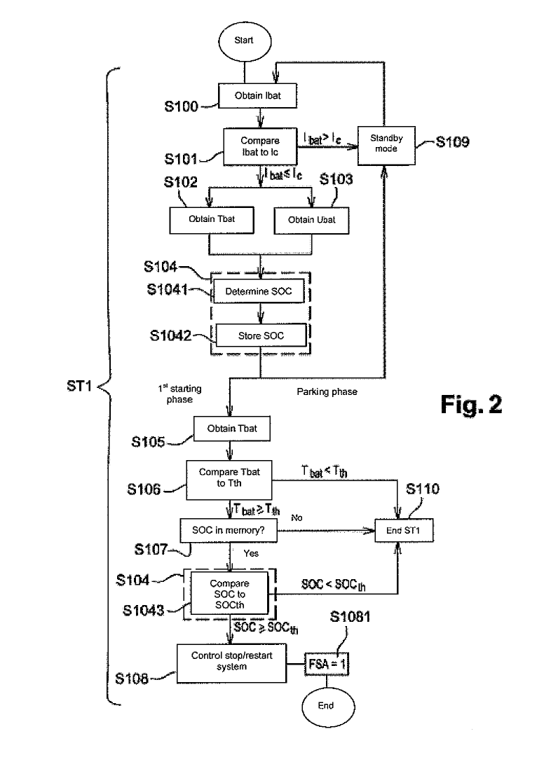

FIG. 2 concerns a sub-module for processing an authorisation of a first engine stop, of the control module 6 from FIG. 1, activated during a parking phase and during a first starting phase, according to one particular embodiment of the method,

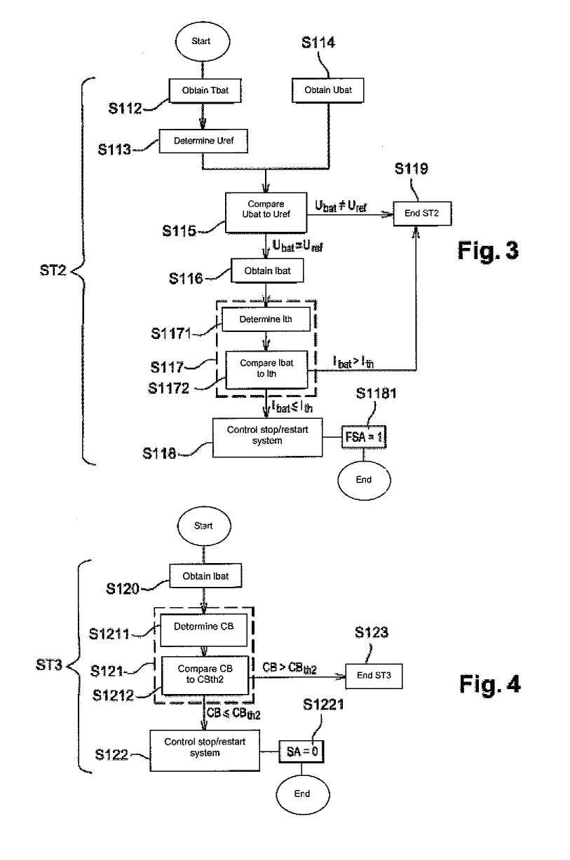

FIG. 3 concerns a sub-module for processing an authorisation of a first engine stop, of the control module 6 from FIG. 1, activated during a first starting phase, according to another particular embodiment of the method,

FIG. 4 concerns a sub-module for processing a prohibition of an engine stop, of the control module 6 from FIG. 1, activated during a phase of normal operation, according to a particular embodiment of the method,

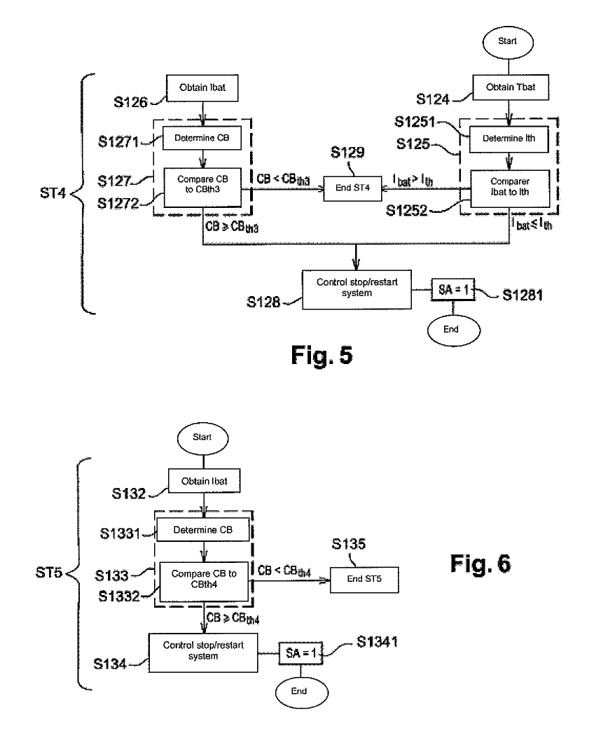

FIGS. 5 and 6 concern a sub-module for processing an authorisation of an engine stop, of the control module 6 from FIG. 1, activated during a phase of normal operation, according to two particular embodiments of the method,

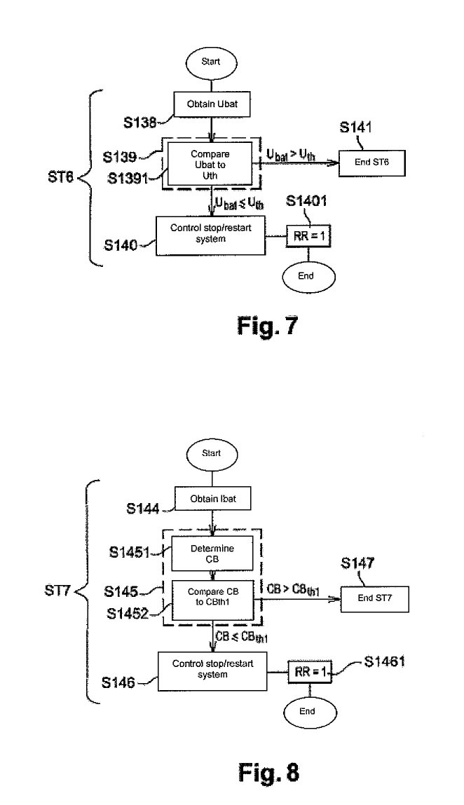

FIGS. 7 and 8 concern a sub-module for processing an engine restart request, of the control module 6 from FIG. 1, activated during a phase of normal operation, according to two particular embodiments of the method, and

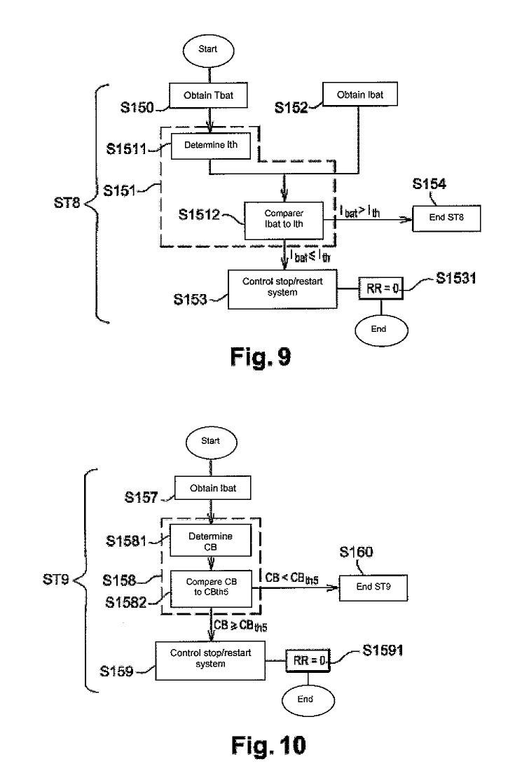

FIGS. 9 and 10 concern a sub-module for processing a cancellation of an engine restart request, of the control module 6 from FIG. 1, activated during a phase of normal operation, according to two particular embodiments of the method.

FIG. 1 shows an engine stop/restart system 1 comprising a reversible polyphase rotary electrical machine 2, a reversible analogue-digital converter 3, a control unit 4, and a control device 5.

The reversible polyphase rotary electrical machine 2 is formed, in the example in question, by a motor vehicle alternator-starter.

The alternator-starter 2 is capable, in addition to being driven in rotation by a heat engine 9 to produce electrical energy (alternator mode), of transmitting torque to this heat engine 9 for starting purposes (starter mode).

As a variant, the alternator-starter can be utilised in an architecture of the recuperative braking type, in order to transform part of the mechanical energy produced by braking into electrical energy.

As a further variant, the engine stop/restart system may comprise a traditional alternator associated with a starter device, instead of the alternator-starter.

The alternator-starter 2, the converter 3 and an energy storage unit 8 are connected in series.

The energy storage unit 8 may consist of a traditionally powered battery, for example of the lead battery type. This battery 8, in addition to powering the alternator-starter during a starting phase (engine mode), allows electrical energy to be supplied to the electrical consumers of the vehicle, for example headlights, a car radio, an air conditioning device, windscreen wipers.

The converter 3 authorises bidirectional transfers of electrical energy between the alternator-starter 2 and the battery 8, these transfers being controlled in particular by the control unit 4 connected to the converter.

The control unit 4 of the engine stop/restart system 1 can be constructed around a microprocessor.

In starter mode (or engine mode), the microprocessor 4 controls the converter 3 in order to draw a DC voltage produced by the battery 8 to power the alternator-starter 2.

In alternator mode (or generator mode), in normal operation or in recuperative braking, the microprocessor 4 controls the converter 3 in order to draw AC voltages produced by the alternator-starter 2, firstly to charge the battery 8, and secondly to power the electrical consumers of the vehicle.

The microprocessor 4 is also connected to an engine control unit 10 capable of managing the heat engine 9.

When the alternator-starter 2 is not drawing any current, in particular during a stop phase of the engine stop/restart system 1, the battery 8 alone has to meet the electrical requirements of the vehicle.

In this case, there are increased risks of a severe and rapid discharge of the battery 8.

According to the invention, the control device 5 of the engine stop/restart system 1 comprises a control module 6 and sensors 7.

The control module may be installed at least partially in the microprocessor.

As a variant, the control module may be installed in a means provided to receive the sensors, said means being arranged in proximity to the battery.

There now follows a more detailed description, making reference to FIGS. 2 to 11, of the functioning of the control module 6 according to the invention. More specifically, it is a detailed description of the control method of the invention implemented in this control module 6.

FIG. 2 concerns a sub-module for processing an authorisation of a first engine stop ST1 of the control module 6. This sub-module ST1 is activated during phases of parking and of first starting, and processes steps S100 to S1 10 of the control method for authorising a first stop (FSA=1) of the heat engine 14.

The parking phase starts when a stop of the heat engine 9 occurs and the electrical power supplied to the vehicle is turned off (an ignition key is withdrawn) during a sufficient length of time, for example 2 hours.

This period enables the battery 4 to stabilise its energetic state, both in heat and in electrical terms.

In the particular embodiment of the method illustrated in FIG. 2, at step S100 the control module 6 obtains a current delivered by the battery 8, referred to as Ibat in the rest of the description.

The current Ibat is provided by the sensors 7. It is, for example, measured by using a shunt.

The current Ibat is then transmitted to step S101.

Step S101 executes a comparison calculation between the current Ibat obtained in step S100 and a predetermined threshold value of current, referred to as Ic.

These steps S100 and S101 make it possible, during the parking phase, to control the quantity of electrical energy supplied by the battery 8 to the electrical consumers.

If the comparison calculation effected at step S101 results in a current Ibat less than or equal to Ic, the control module 6 obtains, at steps S102 and S103 respectively, the temperature of the battery 8 and a voltage at the terminals of the battery 8, respectively referred to as Tbat and Ubat in the rest of the description.

The temperature Tbat obtained at step S102 and the voltage Ubat obtained at step S103 are provided by the sensors 7.

The temperature Tbat corresponds to the internal temperature of the battery 8.

The sensors 7 comprise a temperature probe intended to measure the ambient temperature of the battery 8, and a means of calculating the internal temperature Tbat intended to extrapolate said internal temperature Tbat on the basis of the ambient temperature.

As a variant, it is possible to measure the internal temperature of the battery 8 directly by using a temperature probe positioned, for example, under the battery 8.

These temperature probes can, for example, be of the “NTC” (“Negative Temperature Coefficient”) type.

The temperature Tbat and the voltage Ubat are then transmitted to step S104 for determining an energetic state information of the battery 8.

Step S104 includes a sub-step S1041 for determining a state of charge of the battery 8 depending on the temperature Tbat and the voltage Ubat. This state of charge is referred to as SOC in the rest of the description.

In the example in question, the state of charge SOC is read from a consultation table stored in the memory of the control module 6 on the basis of the temperature Tbat and of the voltage Ubat, this consultation table containing a plurality of state of charge values associated with different predetermined temperatures Tbat and voltages Ubat. These state of charge values are calculated during preliminary tests.

The determined state of charge (SOC) is then stored in memory at sub-step S1042 in the control module 6.

The following step, if the parking phase continues, is step S109, corresponding to a standby mode. This standby mode corresponds to the reiteration of steps S100 to S104 during the parking phase.

In fact, when the parking phase is detected, steps S100 to S104 are launched, then said steps are reiterated, for example 3 times, at a predetermined interval of time, for example 30 minutes. Then, said steps can be reiterated again, for example 3 times, at a predetermined interval of time, for example 24 hours.

Each time a state of charge SOC is determined at sub-step S1041, it is memorised at sub-step S1042 in the control module 6.

If the comparison calculation effected at step S101 results in a current Ibat greater than Ic, the step S109 corresponding to standby mode described above follows step S101.

If the phase of first starting occurs, the control module 6 obtains the temperature Tbat at step S105, in the same way as before, and transmits Tbat to step S106.

Step S106 executes a comparison calculation between this temperature Tbat and a predetermined threshold temperature value, known as Tth. The threshold value Tth is, for example, in the order of −5° C.

If the comparison calculation results in a temperature Tbat which is less than Tth, the control module 6 stops the sub-module for processing an authorisation of a first engine stop ST1 at a step S110.

If the comparison calculation results in a temperature Tbat greater than or equal to Tth, the control module 6 verifies, at step S107, whether a state of charge SOC previously determined during a parking phase has been stored in memory, at sub-steps S1041 and S1042.

If no state of charge has been stored in memory, the control module 6 deactivates the sub-module for processing an authorisation of a first engine stop ST1 at step S110.

If a state of charge SOC has been stored in memory, the control module 6 continues its determination of the energetic state information of the battery 8 by effecting a comparison calculation at sub-step S1043. This comparison calculation is effected between the state of charge SOC determined and stored in memory at sub-steps S1041 and S1042, and a predetermined threshold value of state of charge, known as SOCth, for example in the order of 80%.

If the comparison calculation results in a state of charge SOC greater than or equal to SOCth, the control module 6 controls, at step S108, the engine stop/restart system 1 by means of the microprocessor 4 in order to authorise a stop of the heat engine 14 (FSA=1).

Step S108 includes a sub-step S1081.

So, at sub-step S1081 the control module 6 authorises a stop (FSA=1) of the heat engine 14.

If the comparison calculation results in a state of charge SOC less than SOCth, the control module 6 stops the sub-module for processing an authorisation of a first engine stop ST1 at step S110.

It should be noted that steps S105 and S106 may be executed in the different embodiments of the method according to the invention detailed below.

FIG. 3 concerns another embodiment of a sub-module for processing an authorisation of a first engine stop ST2 of the control module 6. This sub-module ST2 is activated during the phase of first starting and processes steps S112 to S119 of the control method to authorise a first stop (FSA=1) of the heat engine 14.

At step S112, the control module 6 obtains the temperature Tbat and transmits Tbat to step S113.

Step S113 determines a reference voltage, known as Uref, depending on the temperature That determined at step S112.

In the example in questions, the reference voltage Uref is read from a consultation table stored in memory in the control module 6 on the basis of the temperature Tbat, this consultation table containing a plurality of values associated with different predetermined Tbat temperatures.

The control module 6 also obtains, at step S114, the voltage U bat.

Then, step S115 executes a comparison calculation between the voltage Ubat and the determined reference voltage Uref.

If the comparison calculation results in a voltage Ubat different from Uref, the control module 6 deactivates the sub-module for processing an authorisation of a first engine stop ST2 at step S119.

If the comparison calculation results in a voltage Ubat which is essentially equal to Uref, the control module 6 obtains the current Ibat at step S116 and transmits it to a subsequent step, S117, which determines the energetic state information of the battery 8.

Step S117 includes the sub-steps S1171 and S1172.

Sub-step S1171 determines a threshold value of current, known as Ith, depending on the temperature Tbat.

The threshold value Ith is read from a consultation table stored in memory in the control module 6 on the basis of the temperature Tbat, this consultation table containing a plurality of values associated with different predetermined temperatures Tbat.

The current Ith is then transmitted to sub-step S1172, which executes a comparison calculation between the current Ibat and the determined threshold value Ith.

If the comparison calculation results in a current Ibat greater than Ith, the control module 6 stops the sub-module for processing an authorisation of a first engine stop ST2 at step S119.

If the comparison calculation results in a current Ibat less than or equal to Ith, the control module 6 controls, at step S118, the engine stop/restart system 1 via the microprocessor 4 in order to authorise a first stop (FSA=1) of the heat engine 14.

Step S118 includes a sub-step S1181.

At sub-step S1181 the control module 6 authorises a stop (FSA=1) of the heat engine 14.

It should be noted that steps S112 to S115 can be executed in the different embodiments of the method according to the invention detailed below, on condition that the control module 6 comprises a sub-module for processing an authorisation of an engine stop ST2 (FSA=1 and/or SA=1).

FIG. 4 concerns a processing sub-module for prohibiting an engine stop ST3 of the control module 6. This sub-module ST3 is activated during a phase of normal operation, following a stop authorisation (FSA=1 or SA=1) for the heat engine 14, and processes steps S120 to S123 of the control method which take place during this phase, in order to prohibit a stop (SA=0) of the heat engine 14.

In one particular embodiment of the method, at step S120 the control module 6 obtains the current Ibat and transmits it to step S121 for determining the energetic state information of the battery 8.

Step S121 includes the sub-steps S1211 and S1212.

Sub-step S1211 determines an energy balance of the battery 8, referred to as CB in the rest of the description, depending on the current Ibat.

The energy balance is determined by the sum of a quantity of energy input and a quantity of energy output. These quantities of energy correspond to an integration of the current Ibat. In addition, a coefficient, referred to as the efficiency coefficient, can be assigned to at least one quantity of energy.

The energy balance and its change over time are precisely determined by obtaining the current Ibat dynamically.

It should be noted that the energy balance CB is initialised by the control module 6 when a stop authorisation (SA=1) is controlled by this control module 6.

The control module 6 then makes a comparison calculation, at sub-step S1212, between the determined energy balance CB and a predetermined threshold value of energy balance CBth2.

If the comparison calculation results in an energy balance CB greater than CBth2, the control module 6 deactivates the sub-module for processing a prohibition of an engine stop ST3 at step S123.

If the comparison calculation results in an energy balance CB less than or equal to CBth2, the control module 6 controls, at step S122, the engine stop/restart system 1 via the microprocessor 4 to prohibit a stop (SA=0) of the heat engine 14.

Step S122 includes a sub-step S1221.

At sub-step S1221, the control module 6 prohibits a stop (SA=0) of the heat engine 14.

FIG. 5 concerns a sub-module for processing an authorisation of an engine stop ST4 of the control module 6. This sub-module ST4 is activated during a phase of normal operation, following a prohibition of an engine stop (SA=0), and processes steps S124 to S129 of the control method which take place during this phase, to authorise a stop (SA=1) of the heat engine 14.

In one particular embodiment of the method, the control module 6 obtains the temperature Tbat at step S124 and transmits it to step S125 for determining the energetic state information of the battery 8.

Step S125 includes the sub-steps S1251 and S1252.

Sub-step S1251 determines a threshold value of current Ith, depending on the temperature Tbat, the current Ith being read in the same way as before.

In addition, the control module 6 obtains the current Ibat at step S126 and transmits it to sub-step S1252.

Sub-step S1252 executes a comparison calculation between the current Ibat and the determined threshold value Ith.

Moreover, the current Ibat obtained at step S126 is transmitted to step S127 for determining the energetic state information of the battery 8, this step S127 including the sub-steps S1271 and S1272.

Sub-step S1271 determines the energy balance CB of the battery 8 depending on the current Ibat obtained.

Sub-step S1272 executes a comparison calculation between the determined energy balance CB and a predetermined threshold value of energy balance CBth3.

This threshold value CBth3 may be greater than the threshold value CBth2.

If the comparison calculation of sub-step 1252 results in a current Ibat greater than Ith, the control module 6 stops the sub-module for processing an authorisation of an engine stop ST4 at step S129.

If the comparison calculation of the sub-step 1272 results in an energy balance CB less than CBth3, the control module 6 deactivates the sub-module for processing an authorisation of an engine stop ST4 at step S129.

If the comparison calculations executed at sub-steps S1272 and S1252 result respectively in an energy balance CB greater than or equal to CBth3 and in a current Ibat less than or equal to Ith, then the control module 6 controls, at step S128, the engine stop/restart system 1 via the microprocessor 4 to authorise a stop (SA=1) of the heat engine 14.

Step S128 includes a sub-step S1281.

At sub-step S1281 the control module 6 authorises a stop (SA=1) of the heat engine 14.

The energy balance CB is then initialised at a value of zero.

In another particular embodiment of a sub-module for processing an authorisation of an engine stop ST5 of the control module 6, illustrated in FIG. 6, said sub-module ST5 is activated during a phase of normal operation, following an engine stop prohibition (SA=0). Said sub-module ST5 processes steps S132 to S135 of the control method which take place during this phase, to authorise a stop (SA=1) of the heat engine 14.

In the example in question, the control module 6 obtains the current Ibat at step S132 and transmits it to step S133 for determining information about the energetic state of the battery 8.

Step S133 includes the sub-steps S1331 and S1332.

Sub-step S1331 determines the energy balance CB of the battery 8 and transmits it to sub-step S1332.

The control module 6 then executes a comparison calculation at sub-step S1212 between the determined energy balance CB and a predetermined threshold value of energy balance CBth4.

This threshold value CBth4 may be positive or zero.

If the comparison calculation results in an energy balance CB less than CBth4, the control module 6 deactivates the sub-module for processing an authorisation of an engine stop ST5 at step S135.

If the comparison calculation results in an energy balance CB greater than or equal to CBth4, the control module 6 controls the engine stop/restart system 1 at step S134, via the microprocessor 4, to authorise a stop (SA=1) of the heat engine 14.

Step S134 includes a sub-step S1341.

At sub-step S1341 the control module 6 authorises a stop (SA=1) of the heat engine 14.

The energy balance CB is then initialised at a value of zero.

FIG. 7 concerns a processing sub-module for an engine restart request ST6 of the control module 6. This sub-module ST6 is activated during a phase of normal operation, when the heat engine 14 is stopped, and processes steps S138 to S141 of the control method which take place during this phase, to request a restart (RR=1) of the heat engine 14.

In one particular embodiment of the method, the control module 6 obtains the voltage Ubat at step S138 and transmits it to step S139 for determining the energetic state information of the battery 8.

Step S139 includes a sub-step S1391.

Sub-step S1391 executes a comparison calculation between the voltage Ubat obtained and a predetermined threshold value of voltage, referred to as Uth. For example, the voltage Uth may be between 11.5V and 12V for a 14V lead battery.

If the comparison calculation results in a voltage Ubat greater than Uth, the control module 6 stops the processing sub-module for an engine restart request ST6 at step S141.

If the comparison calculation results in a voltage Ubat less than or equal to Uth, the control module 6 controls, at step 140, the engine stop/restart system 1 via the microprocessor 4 to request a restart (RR=1) of the heat engine 14.

Step S140 includes a sub-step S1401.

At sub-step S1401 the control module 6 authorises a restart (RR=1) of the heat engine 14.

In another particular embodiment of a processing sub-module for an engine restart request ST7 of the control module 6, illustrated in FIG. 8, said sub-module ST7 is activated during a phase of normal operation, when the heat engine 14 is stopped, and processes steps S144 to S147 of the control method which take place during this phase, to request a restart (RR=1) of the heat engine 14.

In the example in question, the control module 6 obtains the current Ibat at step S144 and transmits it to step S145 for determining the energetic state information of the battery 8.

Step S145 includes sub-steps S1451 and S1452.

Sub-step S1451 determines the energy balance CB of the battery 8 and transmits it to sub-step S1452.

At sub-step S1452 the control module 6 then executes a comparison calculation between the determined energy balance CB and a predetermined threshold value of energy balance CBth1.

This threshold value CBth1 may be lower than the threshold value CBth2.

If the comparison calculation results in an energy balance CB greater than CBth1, the control module 6 deactivates the processing sub-module for an engine restart request ST7 at step S147.

If the comparison calculation results in an energy balance CB less than or equal to CBth1, the control module 6 controls the engine stop/restart system 1 at step S146 via the microprocessor 4 to request a restart (RR=1) of the heat engine 14.

Step S146 includes sub-step S1461.

At sub-step S1461 the control module 6 authorises a restart (RR=1) of the heat engine 14.

FIG. 9 concerns a sub-module for processing the cancellation of an engine restart request ST8 of the control module 6. This sub-module ST8 is activated during a phase of normal operation, following a request for a restart of the engine (RR=1), and processes steps S150 to S154 of the control method which take place during this phase, to cancel this restart request (RR=0) of the heat engine 14.

In one particular embodiment of the method, the control module 6 obtains the temperature Tbat at step S150 and transmits it to step S151 for determining the energetic state information of the battery 8.

Step S151 includes the sub-steps S1511 and S1512.

Sub-step S1511 determines a threshold value of current Ith, depending on the temperature Tbat, the current Ith being read in the same way as before.

In addition, the control module 6 obtains the current Ibat at step S152 and transmits it to sub-step S1512.

Sub-step S1512 executes a comparison calculation between the current Ibat and the determined threshold value Ith.

If the comparison calculation results in a current Ibat greater than Ith, the control module 6 stops the sub-module for processing the cancellation of an engine restart request ST8 at step S154.

If the comparison calculation results in a current Ibat less than or equal to Ith, the control module 6 controls, at step S153, the engine stop/restart system 1 via the microprocessor 4 to cancel a restart request (RR=0) of the heat engine 14.

Step S153 includes a sub-step S1531.

At sub-step S1531 the control module 6 cancels the restart (RR=0) of the heat engine 14.

In another particular embodiment of a sub-module for processing the cancellation of an engine restart request ST9 of the control module 6, illustrated in FIG. 10, said sub-module ST9 is activated during a phase of normal operation, following an engine restart request (RR=1). Said sub-module ST9 processes steps S157 to S160 of the control method which take place during this phase, to cancel the restart request (RR=0) of the heat engine 14.

In the example in question, the control module 6 obtains the current Ibat at step S157 and transmits it to step S158 for determining the energetic state information of the battery 8.

Step S158 includes sub-steps S1581 and S1582.

Sub-step S1581 determines the energy balance CB of the battery 8 and transmits it to sub-step S1582.

The control module 6 then executes a comparison calculation at sub-step S1582 between the determined energy balance CB and a predetermined threshold value of energy balance CBth5.

This threshold value CBth5 may be positive or zero.

If the comparison calculation results in an energy balance CB less than CBth5, the control module 6 deactivates the sub-module for processing the cancellation of an engine restart request ST9 at step S160.

If the comparison calculation results in an energy balance CB greater than or equal to CBth5, the control module 6 controls, at step S159, the engine stop/restart system 1 via the microprocessor 4 to cancel a restart request (RR=0) of the heat engine 14.

Step S159 includes a sub-step S1591.

At sub-step S1591 the control module 6 cancels a restart (RR=0) of the heat engine 14.

1. A method for controlling an engine stop/restart system (1) fitted to a motor vehicle, the method comprising the steps of:
obtaining at least one parameter (Tbat, Ubat, Ibat) representing the state of an energy storage unit (8),
determining information on the energetic state of the energy storage unit (8) from said at least one obtained parameter (Tbat, Ubat, Ibat), and
controlling the engine stop/restart system (1) depending on the determined energetic state information,
characterised in that the energetic state information is initialised at a predetermined value when the method controls a stop authorisation of the engine stop/restart system (1).

2. A method according to claim 1, characterised in that said parameter includes at least one of the following parameters:
a temperature (Tbat) of the energy storage unit (8),
a voltage (Ubat) of the energy storage unit (8),
a current (Ibat) of the energy storage unit (8).

3. A method according to claim 2, characterised in that the step of determining the energetic state information comprises the sub-steps of:
determining a state of charge (SOC) depending on the voltage (Ubat) and the temperature (Tbat) of the energy storage unit (8), and
comparing the determined state of charge (SOC) to a predetermined threshold value of a state of charge (SOCth).

4. A method according to claim 2, characterised in that the step of determining the energetic state information comprises the sub-steps of:
determining a threshold value of current (Ith) depending on the temperature (Tbat) of the energy storage unit (8), and
comparing the current (Ibat) of the energy storage unit (8) to the determined threshold value of current (Ith).

5. A method according to claim 2, characterised in that the step of determining the energetic state information comprises the sub-steps of:
determining an energy balance (CB) depending on the current (Ibat) of the energy storage unit (8), and
comparing the determined energy balance (CB) to a predetermined threshold value of energy balance (CBth1, CBth2, CBth3, CBth4, CBth5).

6. A method according to claim 2, characterised in that the step of determining the energetic state information comprises a sub-step of comparing the voltage (Ubat) of the energy storage unit (8) to a predetermined threshold value of voltage (Uth).

7. A method according to claim 1, characterised in that the step of controlling the engine stop/restart system (1) includes a sub-step of authorising an engine stop.

8. A method according to claim 3, characterised in that the sub-step of authorising an engine stop is carried out when the state of charge (SOC) is greater than or equal to the threshold value of a predetermined state of charge (SOCth).

9. A method according to claim 4, characterised in that the sub-step of authorising an engine stop is carried out when the current (Ibat) of the energy storage unit (8) is less than or equal to the determined threshold value of current (Ith).

10. A method according to claim 5, characterised in that the sub-step of authorising an engine stop is carried out when the energy balance (CB) is greater than or equal to the predetermined threshold value of energy balance (CBth4).

11. A method according to claim 4, characterised in that the sub-step of authorising an engine stop is carried out when:
the energy balance (CB) is greater than or equal to the predetermined threshold value of energy balance (CBth3), and
the current (Ibat) of the energy storage unit (8) is less than or equal to the determined threshold value of current (Ith).

12. A method according to claim 1, characterised in that the step of controlling the engine stop/restart system includes a sub-step of prohibiting an engine stop.

13. A method according to claim 5, characterised in that the sub-step of prohibiting an engine stop is carried out when the energy balance (CB) is less than or equal to the predetermined threshold value of the energy balance (CBth2).

14. A method according to claim 1, characterised in that the step of controlling the engine stop/restart system includes a sub-step of requesting an engine restart.

15. A method according to claim 6, characterised in that the sub-step of requesting an engine restart is carried out when the voltage (Ubat) of the energy storage unit (8) is less than or equal to a predetermined threshold value of voltage (Uth).

16. A method according to claim 5, characterised in that the sub-step of requesting an engine restart is carried out when the energy balance (CB) is less than or equal to the predetermined threshold value of the energy balance (CBth1).

17. A method according to claim 1, characterised in that the step of controlling the engine stop/restart system includes a sub-step of cancelling an engine restart request.

18. A method according to claim 5, characterised in that the sub-step of cancelling an engine restart request is carried out when the energy balance (CB) is greater than or equal to the predetermined threshold value of the energy balance (CBth5).

19. A method according to claim 4, characterised in that the sub-step of cancelling an engine restart request is carried out when the current (Ibat) of the energy storage unit (8) is less than or equal to the determined threshold value of current (Ith).

20. A method according to claim 1, characterised in that the step of determining the energetic state information of the energy storage unit is preceded by a step of comparing the temperature (Tbat) of the energy storage unit (8) to a predetermined threshold value of temperature (Tth).

21. A method according to claim 1, characterised in that the step of determining the energetic state information is preceded by the steps of:
determining a reference voltage (Uref) depending on the temperature (Tbat) of the energy storage unit (8), and
comparing the voltage (Ubat) of the energy storage unit (8) to the determined reference voltage (Uref).

22. A device (5) for controlling an engine stop/restart system (1) to be fitted to a motor vehicle, containing a control module (6), said control module (6) comprising:
means for obtaining at least one parameter (Tbat, Ubat, Ibat) representing the state of an energy storage unit (8),
means for determining information on the energetic state of the energy storage unit (8) from said at least one obtained parameter (Tbat, Ubat, Ibat), and
means for controlling the engine stop/restart system (1) depending on the determined energetic state information.

23. A device (5) according to claim 1, said control module (6) being integrated at least partially in a control unit (4) and intended to control the engine stop/restart system (1).

24. A device (5) according to claim 22, characterised in that the means for obtaining at least one parameter (Tbat, Ubat, Ibat) representing a state of an energy storage unit consists of sensors (7) provided to obtain at least one of the following parameters:
a temperature (Tbat) of the energy storage unit (8),
a voltage (Ubat) of the energy storage unit (8),
a current (Ibat) of the energy storage unit (8).

25. An engine stop/restart system (1) comprising a rotary electric machine (2), a reversible analogue-digital converter (3) and means for controlling the control device (5) according to claim 22.

26. An engine stop/restart system (1) according to claim 25, characterised in that the rotary electric machine (2) is an alternator-starter.

27. A motor vehicle containing an engine stop/restart system (1) according to claim 25.
